(19) United States
(12) Patent Application Publication
(10) Pub. No.: US 2026/0298626 A1
(43) Pub. Date: Oct. 1, 2026

(54) APPARATUS AND METHOD FOR DETECTION OF DISTANCE SENSOR BEAM MISALIGNMENT

(71) Applicants: Trent Reeb, Kanata (CA); Stephen Mate, Kanata (CA)

(72) Inventors: Trent Reeb, Kanata (CA); Stephen Mate, Kanata (CA)

(21) Appl. No.: 19/629,703

(22) Filed: Mar. 26, 2026

Related U.S. Application Data
(60) Provisional application No. 63/778,480, filed on Mar. 27, 2025.

(51) Int. Cl. G01B 11/27; G01B 11/02; G01B 11/06

(52) U.S. Cl. CPC G01B 11/272; G01B 11/026; G01B 11/06

(57) ABSTRACT

An apparatus and method for detecting beam misalignment in a thickness measurement system employing two opposed distance measurement sensors. The apparatus includes a first and second distance measurement sensor configured to direct respective light beams toward opposite sides of a measurement space, and a rotatable support member disposed between the sensors for receiving and rotating a sample about a rotation axis. The sample has at least one surface inclined at a tilt angle relative to a propagation direction of a corresponding light beam. A controller obtains thickness measurements from the sensors at a plurality of rotational positions of the rotatable support member and detects a presence of beam misalignment between the first and second light beams based on a variation in the thickness measurements across the plurality of rotational positions. The method involves positioning the tilted sample between the opposed sensors, directing the light beams toward the sample surfaces, rotating the sample while obtaining thickness measurements, and analyzing the variation in those measurements to detect beam misalignment.

### CROSS-REFERENCE TO RELATED APPLICATIONS

The present invention claims priority from U.S. Patent Application No. 63/778,480 filed Mar. 27, 2025, which is incorporated herein by reference

### FIELD

The present disclosure relates to thickness measurement devices that use light beams to measure distance.

### BACKGROUND

In industrial processes it is often necessary or desirable to measure product thickness during manufacturing. While several thickness measurement methods exist, one of the most common non-contact thickness measurement methods involves the use of a pair of opposing distance measurement sensors. These sensors measure distance to an object using light-based distance measurement technology. In general, these sensors transmit a beam of light toward the object being measured and measure the returning signal in order to estimate the distance between sensor and sample. With one distance measurement sensor positioned on one side of the sample, and the other positioned on the opposite side of the sample, and with known spacing between the sensors, it is possible to measure the thickness of the sample placed between the sensors. However, these systems work best when the sensor beams are aligned to be coaxial, in order to avoid measurement errors when the product is not perfectly flat or perpendicular to the sensor beams. In general, misalignment of the sensor beams causes the measurement system to be less accurate when measuring angled surfaces and materials.

### SUMMARY

The present disclosure addresses the issue of beam misalignment by providing a means to detect misalignment between the beams of two opposed distance measurement sensors in a thickness measurement system. Once the misalignment is detected, it may be measured and corrected by hardware adjustment, software correction, or a combination thereof, to reduce or eliminate errors in the system caused by the beam misalignment.

An aspect of the present disclosure provides a method and apparatus to detect and, in some embodiments, measure misalignment of the light beams of two opposed distance measurement sensors. A sample having at least one surface inclined at a tilt angle relative to a beam propagation direction of a corresponding one of the sensors is positioned between and within the working range of the sensors. The sample may be of uniform thickness, with parallel first and second surfaces. The thickness of the sample is measured as the sample is rotated about a rotation axis that, in some embodiments, may be approximately parallel to or coincident with an intended common axis of the sensor beams. The rotation may be either continuous or at discrete rotational increments. By analyzing the variation in the thickness measurements at a plurality of rotational positions, ranging, e.g., from 0 to 360 degrees or more, the presence of sensor beam misalignment can be detected. In some embodiments, the magnitude of the misalignment may be determined based at least in part on the amplitude of the variation and the tilt angle. The direction of the beam misalignment may also be determined, e.g., based on a phase of the variation relative to the rotational position of the sample.

In a further aspect of the present disclosure, a system for automatically correcting beam misalignment is provided. The system includes the two opposed distance measurement sensors, a rotatable support member for rotating the sample, an alignment actuator coupled to at least one of the sensors, and a controller. The controller is configured to obtain thickness measurements at a plurality of rotational positions of the sample, detect beam misalignment based on the variation in the measurements, determine at least one of the magnitude and direction of the misalignment, and cause the alignment actuator to adjust the position of the at least one sensor to reduce the misalignment. In some embodiments, the controller may iteratively rotate the sample and adjust the sensor position until the variation is below a predetermined threshold. In some embodiments, a software correction may be applied to subsequent thickness measurements to compensate for any residual beam misalignment. The apparatus may be used for the alignment of two sensor beams in thickness measurement applications.

### BRIEF DESCRIPTION OF THE DRAWINGS

Embodiments disclosed herein will be described in greater detail with reference to the accompanying drawings which represent example embodiments thereof, in which like elements are indicated with like reference numerals, and wherein:

FIG. 1 is a schematic diagram of a thickness measurement system including two opposed distance sensors;

FIG. 2 is a schematic diagram illustrating thickness measurements of an inclined sample;

FIG. 3 is a schematic diagram of an apparatus for detecting misalignment of distance sensor beams in a thickness measurement system;

FIG. 4 is a schematic diagram of the apparatus of FIG. 3 with misaligned beams;

FIG. 5 is a schematic diagram illustrating thickness measurements of an inclined sample in the presence of beam misalignment;

FIG. 6 is a graph showing the thickness of an inclined sample measured by the apparatus of FIG. 3 versus the angle of rotation;

FIG. 7 is a schematic diagram of an embodiment of the apparatus of FIG. 3 for automatic beam misalignment reduction;

FIG. 8 is a schematic diagram of the apparatus of FIG. 3 with the sample in a maximum error position.

### DETAILED DESCRIPTION

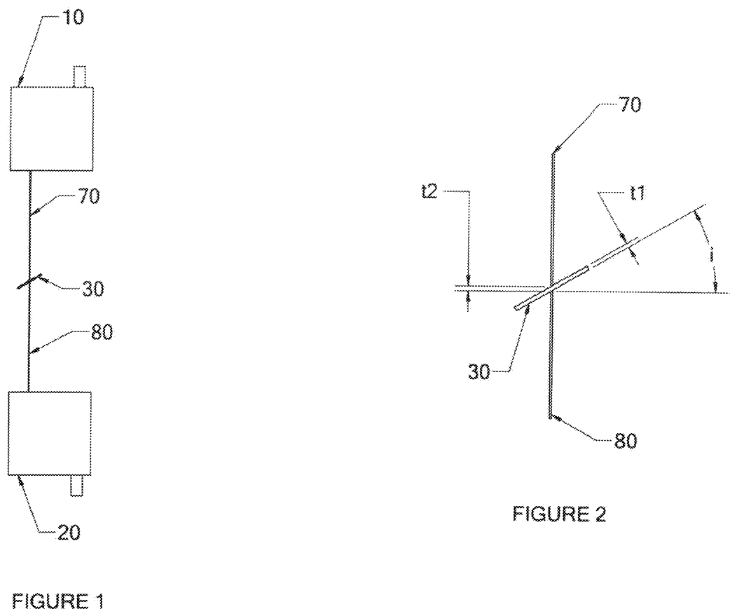

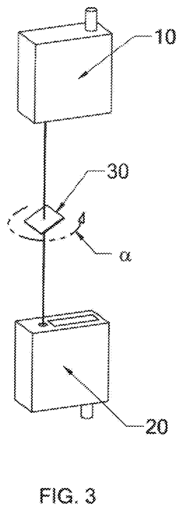

Consider two distance measurement sensors (see FIG. 1, items 10 and 20) arranged so that they are facing each other with a space between, and with an angled sample material (item 30) of arbitrary thickness ‘t1’ placed between the two sensors (FIG. 1). Each of the distance measurement sensors is configured to measure the distance to the nearest side of the sample, the difference between the sum of their distance measurements and the known distance between the sensors 10, 20 being taken as the measured thickness of the sample. Since the sample is angled, the thickness measurement will be slightly increased over the actual thickness, as the distance through the sample in the intended common beam axis direction is larger (FIG. 2) when measuring an angled sample. The thickness will measure t2, which can be calculated as t2=t1/cos (i). Where ‘i’ is the inclination angle of the sample.

Consider next the addition of a rotation of angle “α” (see FIG. 3) to the sample, around the intended common axis of the sensor beams (70 and 80, FIG. 1), or around an axis parallel to the intended common axis of the sensor beams 70, 80. When the sensor beams 70 and 80 are perfectly aligned, as in FIG. 2, the thickness measured is independent of the rotation angle “α”, so that rotating by angle α about the common axis of the two beams does not increase or decrease the measured thickness “T”. The system continues to measure thickness t2 regardless of rotation angle α.

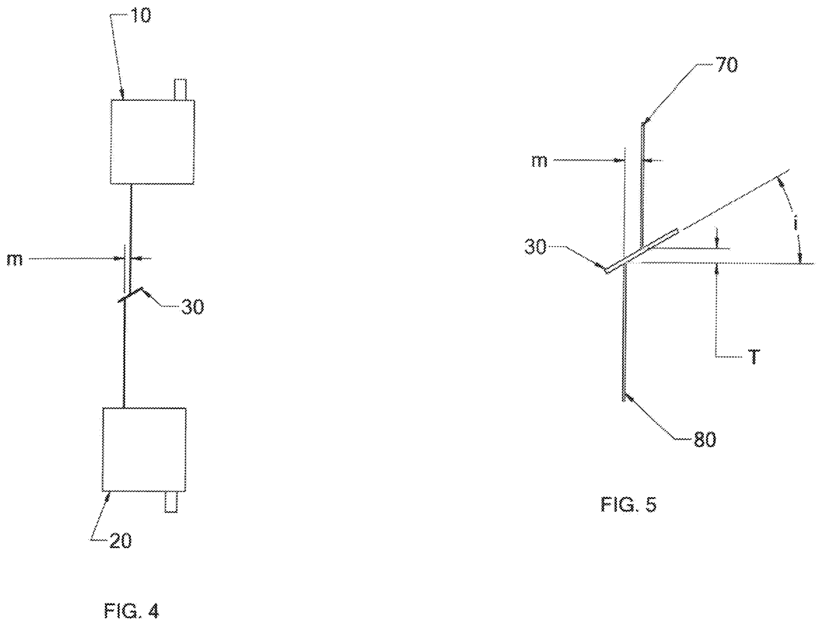

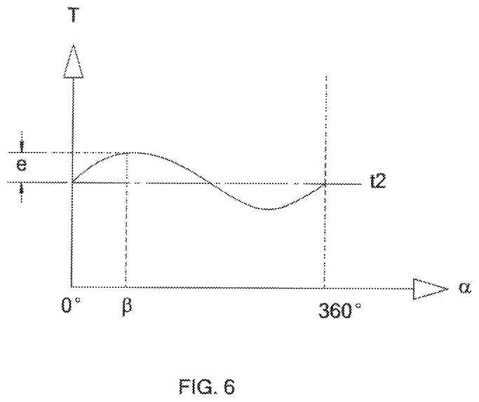

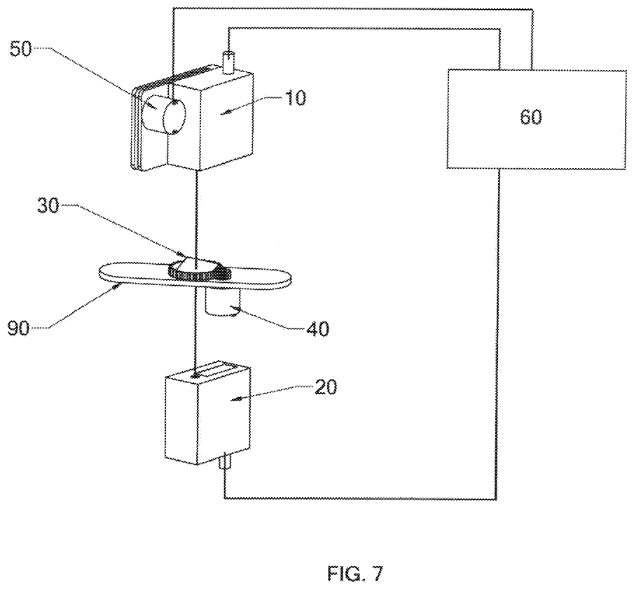

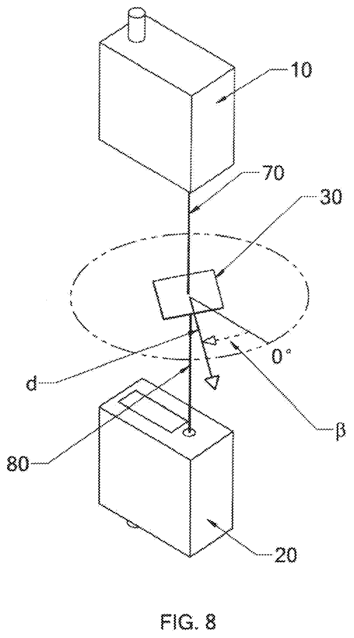

However, if misalignment of the two sensor beams is also present in the system (as in FIG. 4), the thickness measured will change with rotation angle α. The sensor beam misalignment error ‘m’ introduces an additional thickness measurement error to the system (see FIG. 5) such that the measured thickness T varies from the expected angled thickness t2. When plotted showing measured thickness T as a function of rotation angle α, the measured thickness will vary as shown in FIG. 6. The thickness measured by the system will have a maximum at a rotation angle β, when the sample 30 is sloped in the direction ‘d’ of beam misalignment. From this data it is possible to determine both the beam misalignment direction ‘d’ and the magnitude of the error ‘e’ caused by sensor beam misalignment. Knowing the magnitude of the error ‘e’ together with the inclination angle ‘i’ (“sample tilt angle”), one may calculate the misalignment distance ‘m’ as shown in FIGS. 5 and 6 so that it can be corrected.

An example of the apparatus of the present disclosure includes two distance measurement sensors 10 and 20, and a rotatable sample 30 disposed between the sensors 10, 20 so that at least one of two opposing surfaces of the sample 30 facing corresponding sensors 10 or 20 is tilted (“angled”) relative to the sensor beam incident upon the surface. The sample is rotatable about a rotation axis that may be approximately parallel to the beam axis of at least one of the beams 70 and 80. In a preferred embodiment the beams are parallel, and the rotation axis is approximately parallel to the two beams of the distance measurement sensors. The angled surface should be angled so that the angle of incidence of the corresponding beam is between 5 and 85 degrees, or between 10 and 30 degrees, smooth and uniform so as to provide a repeatable measurement when used with the sensors. The axis of sample rotation may be parallel within, e.g., ±20 degrees, or typically ±5 degrees to the common axis of the two sensor beams. The sample is placed between the distance measurement sensors so that it lies within the working range of the distance measurement sensors and in a location where it can be measured by both sensors.

Some embodiments may include means to rotate the sample with at least one of the surfaces thereof inclined relative to the incident beam. Some embodiments may include a means to measure the rotation angle. Some embodiments may include a motor 40 to rotate the sample 30, e.g., as shown in FIG. 7.

In some embodiments the motor 40 may be configured with position control, so that the rotation angle α can be recorded together with the thickness measurement as the sample rotates. A rotary position measurement is not required to detect the beam misalignment but provides feedback that may be useful in determining the direction of the misalignment (see FIG. 6, based on quantity ‘d’) so that it can be easily corrected.

In some embodiments, at least one of the sensors 10, 20 may be provided with an alignment motor 50 to adjust the position of the sensor (e.g., 10) to reduce the measured beam misalignment. In some embodiments a controller (60, FIG. 7) may be provided, to communicate with the distance sensors 10, 20 and to process the distance measurements by the sensors to determine the measured thickness of the sample. In some embodiments, the controller 60 may record the variations of the measured thickness while the sample 30 is rotated, and record at least a magnitude (e.g., amplitude) of the variations of the measured thickness. In some embodiments, the controller 60 may communicate with the alignment motor 50 to adjust the position of the sensor (e.g., 10) to reduce the magnitude of variation of the distance measurements.

### Advantages

Conventional solutions to measure sensor beam alignment use slots, apertures, or complicated beam profiling techniques. Slots, edges and apertures suffer from edge diffraction and are limited by sensor performance as edge detectors, which is not the intended application of the sensors. Beam profiling requires complicated software and hardware and is difficult to deploy in dusty and dirty environments.

By contrast, the method of the present disclosure uses the sensors as distance measurement devices in their intended application and is straightforward to implement in all environments.

The disclosed method allows detection, and may allow measurement, of both the magnitude and the direction of the beam misalignment, and can be completed quickly, typically within a matter of seconds. A basic and commonly available sample, e.g., a flat plate of a uniform thickness, can be used, rather than specialized equipment.

While the example embodiment is shown in the figures, variations can be envisioned that are able to provide similar functionality. One possible variation uses a sample with only one angled surface, for example flat on one side and angled on the opposite side. While some of the features are described above with reference to a continuously rotating angled sample, it may be preferable in some cases to employ indexing of the rotation axis to discrete fixed or variable angles, rather than continuous motion, which may allow for improved coordination with the distance measurement sensors or other systems. Different power sources for the rotation mechanism may be used, for example electric, manual, pneumatic, hydraulic, etc., or the rotation may be driven by mechanical elements nearby.

While the figures described above show vertically opposed sensors, the orientation in space of the sensors may vary. The sensors may be opposed vertically, horizontally, or at any angle relative to the horizon. However, the angled and rotating sample should be placed between the sensors and within the working range so that it can be measured by the sensors. Furthermore, during the measurements one or both of the sensors 10, 20 may be scanned over the sample, which may provide some benefits in characterizing the misalignment, including but not limited to averaging of the distance value supplied by the sensors. Furthermore, the method described above may be used not only for spot type laser triangulation sensors; some embodiments envisioned in the present disclosure make use of alternative technologies including but not limited to confocal chromatic, line laser triangulation, or structured light distance measurement sensors. Alternative sensor technologies may be used rather than spot type laser distance measurement sensors without changing the function of the apparatus.

The beam misalignment detection technique described above may be used together with motorization of the alignment mechanism for fully automatic alignment adjustment. Alternatively, once the beam misalignment is detected and measured using the technique described above, a software correction may be employed to account for sensor misalignment when angled surfaces are measured, where motorized adjustments are not available.

An example apparatus of the present disclosure comprises a thickness measurement device, including at least two distance measurement sensors (See FIG. 1, items 10,20) positioned opposite each other and spaced so that their working ranges allow for thickness measurement of the sample. A sample (item 30) with one or more angled surfaces is positioned, i.e. mounted to a rotatable support member 90, between the two sensors and within the working range of the sensors. A rotation mechanism may be provided, e.g., such shown in FIG. 7, to rotate the angled sample around an axis that may be approximately parallel to the two sensor beams. The method may include rotating the sample while using the distance measurement sensors to measure the sample thickness. Some embodiments of the method may further include recording both the measured thickness ‘T’ and the rotation angle α of the sample (item 30), if a sample rotation measurement is available. When an alignment error is present, the measured thickness of the sample will vary with rotation angle α. Where rotation angle and tilt angle are available, the magnitude m and direction ‘d’ of the misalignment error may be determined by evaluating the relationship between measured thickness and rotation angle. The sensors can then be adjusted to correct the misalignment, or software corrections implemented.

While the present disclosure has been particularly shown and described with reference to example embodiments as illustrated in the drawing, it will be understood by one skilled in the art that various changes in detail may be affected therein without departing from the spirit and scope of the disclosure as defined by the claims.

1. A method for detecting misalignment between light beams of two opposed distance measurement sensors in a thickness measurement system, the method comprising:
positioning a sample between the two opposed distance measurement sensors such that the sample is within a working range of each of the sensors, the sample having a first surface facing a first one of the sensors and a second surface facing a second one of the sensors, at least one of the first and second surfaces being inclined at a tilt angle relative to a beam propagation direction of a corresponding one of the light beams;
directing the light beams from the two opposed distance measurement sensors toward the first and second surfaces, respectively, of the sample to obtain thickness measurements of the sample;
rotating the sample about a rotation axis while obtaining the thickness measurements at a plurality of rotational positions of the sample; and
analyzing a variation in the thickness measurements across the plurality of rotational positions to detect a presence of beam misalignment between the light beams of the two sensors.

2. The method of claim 1, wherein the rotation axis is substantially parallel to or coincident with an intended common axis of the light beams of the two sensors.

3. The method of claim 1, wherein the tilt angle is in a range of 5 degrees to 85 degrees relative to the beam propagation direction.

4. The method of claim 1, wherein the sample has a substantially uniform thickness and the first and second surfaces are substantially parallel to each other.

5. The method of claim 1, wherein the rotating comprises one of continuously rotating the sample through at least 360 degrees and indexing the sample to a plurality of discrete rotational positions.

6. The method of claim 1, wherein analyzing the variation comprises detecting oscillations in the thickness measurements as a function of rotational position, and further comprising determining at least one of a magnitude and a direction of the beam misalignment based on at least one of an amplitude and a phase of the oscillations.

7. The method of claim 6, further comprising adjusting a position of at least one of the two sensors to reduce the variation in the thickness measurements responsive to the detected beam misalignment.

8. The method of claim 1, further comprising applying a software correction to the thickness measurements to compensate for the detected beam misalignment.

9. The method of claim 1, wherein only the first surface is inclined at the tilt angle and the second surface is substantially perpendicular to the beam propagation direction of the second sensor.

10. An apparatus for detecting beam misalignment in a thickness measurement system, the apparatus comprising:
a first distance measurement sensor configured to direct a first light beam toward a first side of a measurement space;
a second distance measurement sensor opposed to the first distance measurement sensor and configured to direct a second light beam toward a second side of the measurement space opposite the first side;
a rotatable support member disposed in the measurement space between the first and second distance measurement sensors and configured to receive and rotate a sample about a rotation axis, such that when a sample having at least one surface inclined at a tilt angle relative to a propagation direction of a corresponding one of the first and second light beams is supported by the rotatable support member, the sample is within a working range of each of the first and second distance measurement sensors; and
a controller operatively coupled to the first and second distance measurement sensors and configured to:
obtain thickness measurements from the first and second distance measurement sensors at a plurality of rotational positions of the rotatable support member, and
detect a presence of beam misalignment between the first and second light beams based on a variation in the thickness measurements across the plurality of rotational positions.

11. The apparatus of claim 10, wherein the controller is further configured to determine at least one of a magnitude and a direction of the beam misalignment based on at least one of an amplitude and a phase of oscillations in the thickness measurements.

12. The apparatus of claim 10, further comprising a motor coupled to the rotatable support member for rotating the rotatable support member, the motor being configured for position control to provide a signal indicative of a rotational position of the rotatable support member to the controller.

13. The apparatus of claim 10, further comprising an alignment actuator coupled to at least one of the first and second distance measurement sensors, wherein the controller is configured to cause the alignment actuator to adjust a position of the at least one sensor to reduce the variation in the thickness measurements.

14. The apparatus of claim 10, wherein the first and second distance measurement sensors comprise laser-based distance measurement sensors selected from the group consisting of laser triangulation sensors, confocal chromatic sensors, line laser triangulation sensors, and structured light sensors.

15. The apparatus of claim 10, wherein the rotation axis is substantially parallel to an intended common axis of the first and second light beams.

16. A system for automatically correcting beam misalignment in a thickness measurement system, the system comprising:
a first distance measurement sensor and a second distance measurement sensor arranged in opposition and defining a measurement space therebetween;
a rotatable support member disposed in the measurement space and configured to receive and rotate a calibration sample about a rotation axis, the rotatable support member being positioned such that a calibration sample supported thereon is within a working range of each of the first and second distance measurement sensors;
an alignment actuator coupled to at least one of the first and second distance measurement sensors and configured to adjust a position of the at least one sensor; and
a controller operatively coupled to the first and second distance measurement sensors, the rotatable support member, and the alignment actuator, the controller configured to:
obtain thickness measurements at a plurality of rotational positions of the rotatable support member,
detect beam misalignment between light beams of the first and second distance measurement sensors based on a variation in the thickness measurements,
determine at least one of a magnitude and a direction of the beam misalignment, and
cause the alignment actuator to adjust the position of the at least one sensor to reduce the beam misalignment.

17. The system of claim 16, wherein the controller is configured to iteratively cause the rotatable support member to rotate and adjust the alignment actuator until the variation in the thickness measurements is below a predetermined threshold.

18. The system of claim 16, wherein the controller is further configured to apply a software correction to subsequent thickness measurements to compensate for any residual beam misalignment.

19. The system of claim 16, further comprising a calibration sample supported by the rotatable support member, the calibration sample having a uniform thickness and comprising a flat plate with two parallel surfaces mounted to the rotatable support member at a tilt angle relative to a propagation direction of a light beam of a corresponding one of the first and second distance measurement sensors.

20. The system of claim 16, wherein the first and second distance measurement sensors are oriented in a configuration selected from the group consisting of vertically opposed, horizontally opposed, and angularly opposed.
